(19) United States
(12) Patent Application Publication
(10) Pub. No.: US 2026/0170159 A1
(43) Pub. Date: Jun. 18, 2026

(54) MODELING PERMISSION RISK IN THE CLOUD

(71) Applicant: Andromeda Security, Los Altos, CA (US)

(72) Inventors: Kevin Alejandro Roundy, El Segundo, CA (US); Robin O. Roundy, Provo, UT (US); Gaurav Rastogi, San Francisco, CA (US); Kamalakannan Congevaram Muralidharan, Milpitas, CA (US)

(21) Appl. No.: 19/416,321

(22) Filed: Dec. 11, 2025

Related U.S. Application Data
(60) Provisional application No. 63/733,339, filed on Dec. 12, 2024.
(60) Provisional application No. 63/764,761, filed on Feb. 28, 2025.

(51) Int. Cl. G06F 21/62; G06F 21/57

(52) U.S. Cl. CPC G06F 21/62; G06F 21/577; G06F 2221/2125

(57) ABSTRACT

A plurality of permissions associated with a user is determined. A corresponding risk associated with each of the plurality of permissions is determined. An aggregate risk associated with the plurality of permissions associated with the user as a whole is determined to generate an identity risk based on the determined corresponding risk associated with each of the plurality of permissions. It is determined which of the plurality of permissions are used by the user. One or more roles for the user are configured based on the determined aggregate risk and the determined use.

### CROSS REFERENCE TO OTHER APPLICATIONS

This application claims priority to U.S. Provisional Patent Application No. 63/733,339 entitled MODELING PERMISSION RISK IN THE CLOUD filed Dec. 12, 2024, and claims priority to U.S. Provisional Patent Application No. 63/764,761 entitled MODELING PERMISSION RISK IN THE CLOUD filed Feb. 28, 2025, each of which is incorporated herein by reference for all purposes.

### BACKGROUND OF THE INVENTION

Modern cloud computing environments allow cloud administrators to assign a large number of fine-grained access permissions to users, service identities, groups, and automated workloads. As cloud service providers introduce new services and features, the number of available permissions continues to grow, often reaching into the tens of thousands of discrete permissions for a single provider. Due to the granularity and volume of these permissions, it is difficult for administrators to maintain a complete understanding of the impact and appropriate usage of each permission, which frequently results in users being granted more permissions than necessary for their operational needs.

When a user or service identity possesses excessive or unnecessary permissions, the compromise of that identity's credentials can result in a significantly expanded attack surface and a corresponding increased blast radius. For example, an identity may be granted write or administrative access to a particular service, despite rarely using such access. If a malicious actor obtains the corresponding credentials, the actor may perform destructive or unauthorized actions, such as deploying malicious code, exfiltrating data, altering configurations, or executing a ransomware attack.

### BRIEF DESCRIPTION OF THE DRAWINGS

Various embodiments of the invention are disclosed in the following detailed description and the accompanying drawings.

FIGS. 1A-1D illustrate examples of permission bindings at different hierarchical scopes within a cloud computing environment.

FIG. 2 is a block diagram illustrating a system to model risk associated with permissions in the cloud and configure a permission set for one or more users in accordance with some embodiments.

FIG. 3 illustrates a risk classification table in accordance with some embodiments.

FIG. 4 is an example table illustrating role-to-user-to-context mapping in accordance with some embodiments.

FIG. 5 is an example table illustrating comparison of risk scores computed using two different risk models in accordance with some embodiments.

FIGS. 6A-6C are example tables illustrating account-level risk aggregation in accordance with some embodiments.

FIGS. 6D and 6E are example tables illustrating account-level risk aggregation using different vector norms in accordance with some embodiments.

FIG. 6F is a graph illustrating a logistic function used for non-linear normalization of aggregated risk values in accordance with some embodiments.

FIG. 7A-7C are graphs illustrating a family of logistic transformation functions used for risk normalization in accordance with some embodiments.

FIG. 8 is a table illustrating an example permission-governance matrix defining allowable access levels and associated risk exposures in accordance with some embodiments.

FIG. 9 is a flow diagram illustrating a process to determine a risk associated with an identity in accordance with some embodiments.

FIG. 10 is a flow diagram illustrating a process to determine a risk associated with a tenant in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

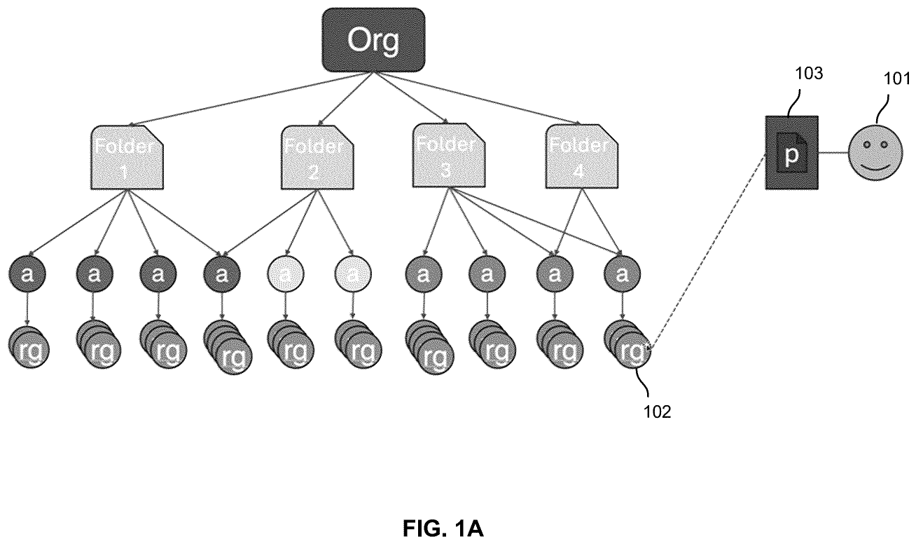

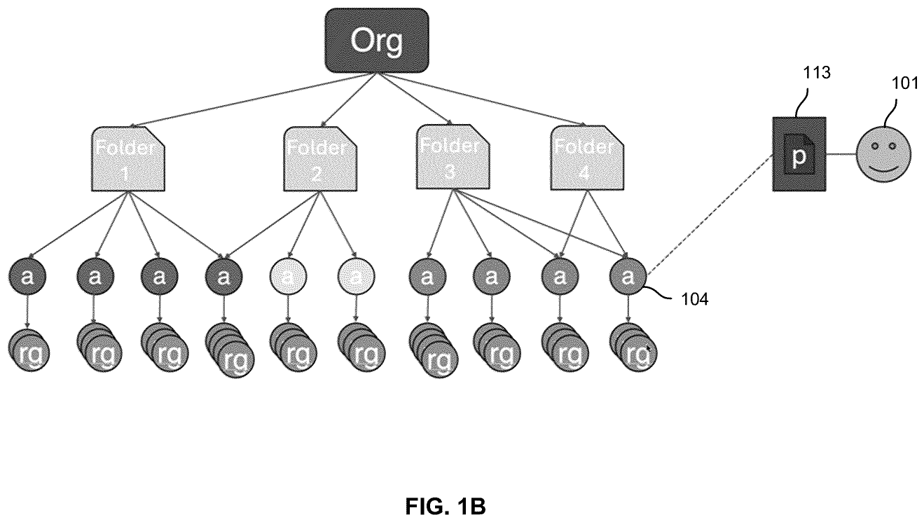

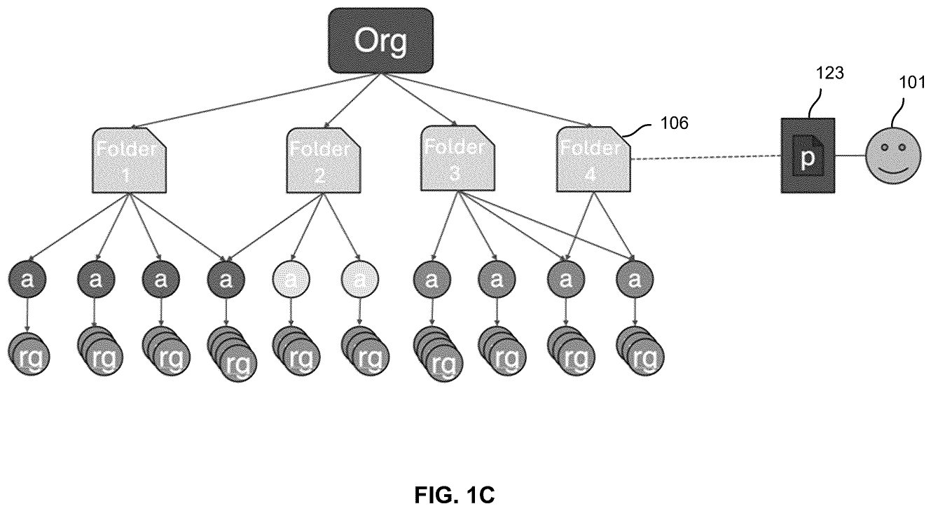

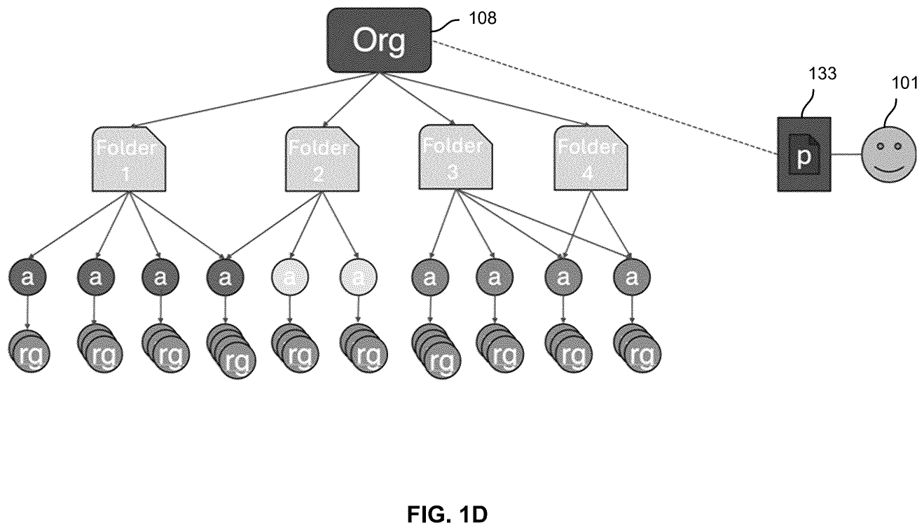

A challenge in modern cloud environments is that access privileges may be granted at multiple hierarchical levels, and identical permissions sets can yield vastly different security outcomes depending on the scope at which they are applied. To illustrate these problems, FIGS. 1A-1D show how the binding scope of a permission set influences the operational impact and blast radius of the associated privileges.

As illustrated in FIG. 1A, cloud computing platforms often organize resources in hierarchical structures in which an organization may include multiple folders, projects, and individual resources. A role or permission set 103 may be bound at various levels of this hierarchy, and the scope at which the binding occurs directly affects the extent of the actions that an identity 101 may perform. For example, a “read-only” access policy attached to a single storage resource 102 enables only limited operations on that resource and does not confer access to other services or resources within the environment.

As illustrated in FIG. 1B, binding a permission set 113 at an account-level scope extends the identity 101's authorized actions to all resources within that account 104. Thus, a policy that is low-impact when applied to a single resource can affect a significantly larger blast radius when applied at an account level.

As illustrated in FIG. 1C, binding a permission set 123 at a folder-level scope further expands its reach to all accounts, projects, or subscriptions contained within that folder 106. While some cloud providers, such as Google Cloud Platform (GCP) and Microsoft Azure, natively support folder-based hierarchies, other cloud providers, such as Amazon Web Services (AWS), provide similar hierarchical groupings through alternative constructs. Binding at the folder level therefore magnifies the impact of the permissions across multiple accounts simultaneously.

As illustrated in FIG. 1D, binding a permission set 133 at an organizational-level scope grants the identity 101 the authorized actions across all subordinate folders, accounts, projects, subscriptions, and resources within the entire organization 108. This represents the broadest scope of application, yielding the maximum operational reach and blast radius for a single permission binding.

The materially different levels of access and security exposure associated with the hierarchical bindings illustrated in FIGS. 1A-1D demonstrate that the scope at which a permission set is applied can significantly affect its operational impact within a cloud environment. As cloud deployments expand to include numerous accounts, projects, and organizational units, there is an increasing need for mechanisms that assess access privileges and associated risk in a manner that reflets the scope of the permission binding across such hierarchical levels. This lack of scope-aware risk assessment prevents security administrators from properly identifying high-risk privilege assignments and impedes effective least-privilege management across large, multi-account cloud environments.

Systems and methods for computer-implemented modeling of risk associated with cloud permissions are disclosed herein. The disclosed techniques provide a comprehensive framework for evaluating and managing cloud permission risk by computing and correlating risk metrics across multiple hierarchical scopes, ranging from individual permissions to identities, accounts, providers, and tenant-wide contexts, to generate accurate indicators of blast radius and excessive privilege conditions. This scope-aware aggregation provides a technical improvement over conventional cloud permission assessments by enabling automated, contextualized risk scoring that reflects the operational impact of privilege misuse or identity compromise, rather than treating permissions or roles in isolation.

The disclosed approach facilitates automated detection and prioritization of high-impact privilege exposures, excessive or unused access, anomalous or risky identity behavior, and privilege accumulation across cloud environments. By generating normalized risk scores across each layer of the cloud environment and propagating risk upward through hierarchical scopes, the system provides a unified, tenant-wide representation of risk posture. This supports effective least-privilege and zero-standing-privilege access governance at scale, enabling organizations to proactively reduce attack surface, limit blast radius, and respond intelligently to elevated risk conditions across large, distributed, multi-account and multi-provider cloud infrastructures.

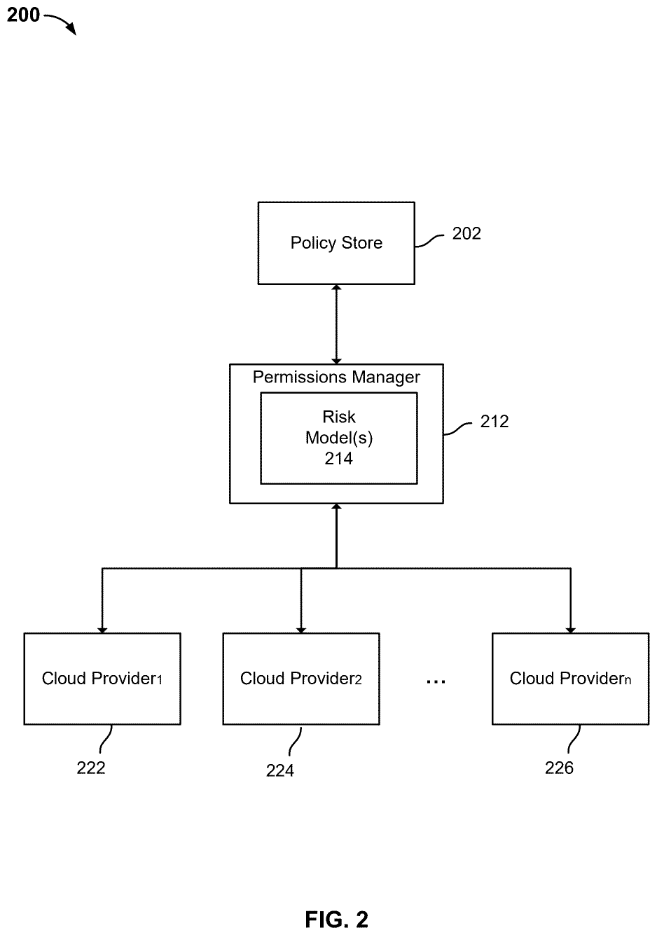

FIG. 2 is a block diagram illustrating a system to model risk associated with permissions in the cloud and configure a permission set for one or more users in accordance with some embodiments. In the example shown, system 200 includes a policy store 202 (e.g., a database or service) configured to store role definitions, policies, and permission sets associated with a tenant.

System 200 further includes a permissions manager 212 configured to obtain a set of permissions associated with a user from policy store 202. Permissions manager 212 may implemented as one or more computers, servers, virtual machines, containers, cloud services, or combinations thereof. Permissions manager 212 is configured to communicate with a plurality of cloud providers, including cloud provider 222, cloud provider 224, and cloud provider 226 (e.g., Amazon Web Services, Microsoft Azure, Google Cloud, etc.). Although FIG. 2 depicts three cloud providers, permissions manager 212 may communicate with 1: n cloud providers.

Each cloud provider 222, 224, . . . , 226 is associated with a corresponding set of fine-grained permissions. Each fine-grained permission corresponds to a particular service provided by the cloud provider. Permissions can be characterized based on one or more attributes, such as access level, service, resource exposure, sensitive data exposure, and/or privilege escalation.

A cloud provider may group a plurality of fine-grained permissions into a role, policy, or permission set. Cloud providers may define and maintain hundreds or even thousands of these roles, policies, or permission sets. In some embodiments, a cloud customer may define one or more roles, policies, or permission sets.

Users of the cloud services are associated with one or more permission groupings. Permissions manager 202 is configured to determine a subset of permissions within a permission grouping to assign to a user based at least in part on (i) a risk score associated with the permission grouping and (ii) historical usage of the permissions by the user. Usage may be determined based on activity logs or access telemetry.

In some embodiments, an initial set of permissions assigned to a user may exceed those required by the user. Permissions manager 212 is configured to reduce the number of permissions associated with the user to reduce a potential impact of accidental or malicious actions and reduce the attack surface. Upon determining an updated set of permissions for the user, permissions manager 212 may store the updated set of permissions in policy store 202. In some embodiments, permissions manager 212 is configured to update policy store 202 with metadata indicating when the modification occurred, a rationale for the update (e.g., risk reduction or removal due to non-use), and an identity of the component or user initiating the change. The updated set of permissions may enforce a least-privilege access model by ensuring that the user is granted only permissions necessary to perform job functions. In some embodiments, permissions manager 204 may further support just-in-time (JIT) access by enabling temporary elevation of permissions for a limited duration, after which the elevated permissions are automatically removed and the updated permissions are written back to policy store 202.

Permissions manager 202 includes one or more risk models 214. The one or more risk models 214 are configured to determine a blast impact risk, an identity risk, an account risk, and a provider risk.

### Blast Impact Risk

Blast Impact Risk (BIR) represents the potential impact, or “blast radius,” that could result if an identity's granted permissions were misused or compromised. The BIR reflects the impact that a set of permissions can cause within a particular scope, such as an account or subscription, a folder or project, a provider, or a lower-level boundary, such as a resource or resource group. In some embodiments, BIR is expressed as a normalized score, such as on a 0-100 scale and may be based on factors including the inherent risk of the permissions contained in the policy, the criticality of the scope, and whether the scope contains sensitive data. In essence, BIR quantifies the potential authorized reach of an identity if compromised. BIR may be calculated at multiple levels, both for individual identities and across all identities within a defined scope.

For a given identity, BIR may be computed at multiple hierarchical levels. At the policy level, a policy-scoped BIR represents the blast impact of a specific policy assigned to the identity within an account. The policy-scoped BIR for a policy within an account is constant for all identities to which the policy is assigned, as it reflects the inherent blast impact of the policy itself in the context of that account. When the identity is assigned the policy, the corresponding policy-scoped BIR is attributed to the identity.

At the account level, the identity's account-scoped BIR represents the aggregated blast impact of all policies assigned to the identity within that account. At the provider level, the identity's provider-scoped BIR reflects the aggregated blast impact of all policies assigned to the identity across all accounts associated with the provider. The provider-scoped BIR may serve as an input into the identity's overall risk score. At the tenant level, the identity's tenant-scoped BIR represents the aggregated blast impact of all policies assigned to the identity across all cloud providers associated with the tenant.

BIR may also be computed in the aggregate across all identities within a given scope. At the account level, the account-scoped BIR across identities represents the cumulative blast impact for an account based on all assigned policies for all identities within that account. At the provider level, the provider-scoped BIR across identities represents the cumulative blast impact for a provider based on all identities across all accounts within that provider. These aggregated BIR values provide a higher-level of exposure, enabling organizations to understand the total potential blast impact at the account or provider level, independent of any single identity.

The Identity BIR for a policy within an account is determined by combining two primary factors: the Entitlement Blast Index (EBI) and the Resource Criticality Index (RCI). The EBI reflects the inherent impact potential of a permission based on the characteristics of the permission and the cloud service with which it is associated. The RCI is based on the criticality of the account and its underlying resources, incorporating customer-specific attributes such as environment classification, data sensitivity, and other relevant contextual factors.

### Entitlement Blast Index

### EBI Calculation for Each Permission/Action

Each cloud provider maintains an extensive catalog of permissions, which may be ingested and continuously maintained within a datastore together with a defined set of attributes for each permission. For example, for AWS, more than 14,000 permissions may be stored along with enhanced metadata, including the permission identifier (e.g., s3:createBucket in AWS or storage.buckets.create in GCP), an assigned access level and associated risk, and a more granular categorization than the native provider classifications. While AWS groups permissions into broad access levels, such as Read, Write, List, Management, and Tagging, some embodiments, apply a finer-grained taxonomy to distinguish actions with materially different impact (e.g., delete vs. modify, both of which AWS classifies as write). In some embodiments, each category is assigned a risk rating (initially high, medium, or low, with potential expansion to a higher cardinality scale), and mapped to an ordered set ranging from low-risk to high-risk actions, including: List, ReadMetadata, WriteTag, DeleteTag, ReadData, WriteMetadata, Create, WriteData, DeleteData, Delete, and PermissionsManagement.

Additional attributes captured for each permission may include the cloud service to which the permission applies, mapped to one of approximately 30 service categories to enable consistent scoring across hundreds of services, as well as Boolean indicators for Sensitive Information Exposure, which flags permissions (often ReadMetadata or ReadData) that could reveal sensitive data, such as API keys or credentials; Privilege Escalation Exposure, which identifies permissions that enable a user to elevate their own access or grant elevated access to others, including indirect escalation vectors through tag or organization modification; Resource Exposure, which highlights permissions that can be used to unintentionally or intentionally expose cloud resources to the public; and Deprecated, which marks permissions that have been removed or deprecated by the provider but may still be in active use by the tenant. These enriched attributes enable more accurate risk evaluation and support lifecycle updates as cloud providers evolve their permission models.

EBI represents a quantitative measure of the inherent blast impact associated with a given permission. EBI reflects the potential scope and severity of the actions permitted by an entitlement when exercised by an identity within a cloud environment. In determining the EBI for a permission, various attributes of the entitlement may be considered, including, but not limited to the operational effect of the action, the sensitivity of the associated resource or data, the potential for privilege escalation, and the service category to which the permission belongs.

In some embodiments, the EBI for a permission p may be calculated as a function of multiple weighted factors, such as access impact, service criticality, and exposure characteristics, according to the following general formulation:

$$EBI ( p ) = {w}_{c ( v ) ( p ) )} {w}_{l ( p )} {\prod }_{j} ( 1 + {f}_{j} ( p ) {w}_{j} )$$

The term w_{c(v(p))} represents the base weight associated with the service category to which the service v of the permission p belongs, reflecting the relative sensitivity of different cloud services. The term wₗ₍ₚ₎ represents the weight associated with the inherent impact of the permission's action type l (such as read, write, delete, or administrative control). The product component

$${\prod }_{j} ( 1 + {f}_{j} ( p ) {w}_{j} )$$

applies risk amplification based on the presence of specific risk factors, where each ƒⱼ(p) indicates whether factor j applies to permission p, and wⱼ is the corresponding weight of that factor. These factors may include, for example, sensitive data exposure, privilege escalation potential, resource-exposure, or deprecated. Each applicable factor increases the EBI multiplicatively, enabling the model to account for compounding risk and ensuring that high-impact permissions in sensitive services receive appropriately elevated scores.

In some embodiments, the EBI for a permission is further refined based on its context. When a permission is scored in the context of an account a (or other scope, such as a folder, or organization) and resources S, EBI may be represented as:

$$EBI ( p , a , S ) = ( 1 + {w}_{n} n ( a , p ) ) {1}_{s ( p ) ∈ S} {w}_{c ( v ( p ) )} {w}_{l ( p )} {\prod }_{j} ( 1 + {f}_{j} ( p ) {w}_{j} )$$

In the term 1+wₙn(a,p), n is a Boolean tag indicating the sensitivity of the data in the account. If the account has no sensitive information, the term is set to 1. Otherwise, the term is 1+wₙn(a, p) where wₙ is an optimized weight that increases the risk of permissions that exist in the context of sensitive accounts. The formula n(a,p) indicates that the permission itself may be taken into account when determining whether n(a,p) yields a 1 or 0. In certain embodiments, the weight wₙ is only applied to permissions that provided access to or allow modification of sensitive data.

In the term 1_{s(p)∈S}, the resource s associated with the permission p is first identified; this mapping is represented as s(p). The indicator evaluates to 1 if s(p) is included in the set of resources S to which the permission is applicable, and 0 otherwise. As a result, the EBI contribution of a permission, such as s3:ListBuckets becomes zero when the resource constraints on the role prevent the permission from accessing any of the resources in S, since the action would have no effective impact (for example, s3:ListBuckets would have no impact when s3 service is not included in the resources in S).

### BIR Calculation for a Policy

After computing and storing the EBI values for all permissions, these values may then be used to derive EBI of a policy within a given account. The EBI of a policy in an account is determined as a function of the EBIs of all permissions granted by the policy, adjusted by a weighting factor that reflects the criticality and sensitivity of the account. As a result, the same policy may produce different EBI values across accounts of differing importance. For example, if an identical policy is granted in both a Test account and a Production account, the policy in the Production account will yield a higher EBI due to the greater criticality and sensitivity associated with the Production environment.

With regard to aggregating EBI permission scores into an EBI policy score, the Lₚ vector norms provide multiple options to consider.

In some embodiments, L₁ norm: linear sum of individual policy scores:

$${EBI}_{policy} = {\sum }_{i} ( {EBI}_{permission \_ i} )$$

In some embodiments, L₂ norm: square root of sum of squared individual permission scores. This weighs higher scores more heavily. It represents a middle ground in between L₁ and L_{∞}:

$${EBI}_{policy} = {( {\sum }_{i} {( {EBI}_{permission \_ i} )}^{2} )}^{1 / 2}$$

In some embodiments, L_{∞} is identical to the max function. As p approaches infinity, the Lₚ norm gets closer and closer to max:

$${EBI}_{policy} = {( {\sum }_{i} {( {EBI}_{permission \_ i} )}^{∞} )}^{1 / ∞}$$

In some embodiments, L₀ norm: it represents a count of the number of permissions there are in a policy.

An optimizer may be used to determine the optimal value of p in Lₚ norm, typically yielding p≈3. Other norms are possible, the Lₚ norm would be defined generally in this context as:

$${EBI}_{policy} = {( {\sum i}_{i} {( {EBI}_{permission \_ i} )}^{p} )}^{1 / p}$$

The actual BIR of a role is normalized to a fixed range. In some embodiments this range is from 0-100. Thus, combining the score of permissions to arrive at the risk of the policy and adding normalization:

$$Risk ( a , r , S ) = {w}_{crit ( a )} logistic ( m , x 0 , g , {[ {\sum }_{p ∈ r} {( ( 1 + {w}_{n} ( a , p ) ) {1}_{s ( p ) ∈ S} {w}_{c ( v ( p ) )} {w}_{l ( p )} {\prod }_{j} ( 1 + {f}_{j} ( p ) {w}_{j} ) )}^{y} ]}^{1 / y} )$$

Or to simplify the formula and state it in terms of Permission EBI's, the following equivalent definition:

$$Risk ( a , r , S ) = {w}_{crit ( a )} logistic ( m , x 0 , g , {[ {\sum }_{p ∈ r} ( {EBI ( a , r , S )}^{y} ]}^{1 / 2} )$$

The term

$${\sum }_{p ∈ r} {[ ( EBI + {( a , r , S )}^{y} ]}^{1 / y}$$

is the L_{y} norm portion of the calculation (L_{y} is used rather than Lₚ because p represents a permission).

The role of the logistic formulation term logistic (m, x0, g, . . . ) is to help scale the raw risk of a role to a 0 to 100 range, by optimizing to determine parameters supremum m, x offset x0, and a growth-rate g. The y-offset y0 in terms of parameters m, x0, and g so that the the logistic function passes through the (0,0) origin. Since

$$logistic ( m , {x}_{0} , g , 0 ) -= \frac{m}{1 + exp ( g \cdot {x}_{0} )} ,$$

$${y}_{0} = - \frac{m}{1 + exp ( g \cdot {x}_{0} )} .$$

the offset may be selected as

The term w_{crit(a)} weighs the risk of a role binding in the context of an account a (or other scope) and set of resources S by the criticality level of the scope.

### Impact Metric for a Role:

Although a 0-100 integer risk score is typically preferred for customer-facing reports, some users may also require access to an unbounded, non-rounded impact value that reflects the raw underlying score and allows more granular visibility into incremental changes. Accordingly, the impact for a role is defined as the same formulation described above, but without applying the function's normalization:

$$Impact ( u , a , r , S ) = {w}_{crit ( a )} ( {[ {\sum }_{p ∈ r} {( ( 1 + {w}_{n} n ( a , p ) ) {1}_{s ( p ) ∈ S} {w}_{c ( v ( p ) )} {w}_{l ( p )} {\prod }_{j} ( 1 + {f}_{j} ( p ) {w}_{j} ) )}^{y} ]}^{1 / y} )$$

### Aggregation

The original, non-aggregated formulation for calculating a specific user's risk for a specific role in an account and its associated resources was defined as follows:

$$Risk ( u , a , r , S ) = {w}_{crit ( a )} logistic ( m , x 0 , g , {[ {\sum }_{p ∈ r} {( ( 1 + {w}_{n} ( a , p ) ) {1}_{s ( p ) ∈ S} {w}_{c ( v ( p ) )} {w}_{l ( p )} {\prod }_{j} ( 1 + {f}_{j} ( p ) {w}_{j} ) )}^{y} ]}^{1 / y} ]$$

To compute a user's overall risk across all roles R assigned within an account, the permissions granted by each role r∈R are first combined into a single consolidated set, effectively treating the union of permissions as a “composite role.” During this process, permissions that appear in multiple roles are deduplicated. This approach is preferred over aggregating individual Risk(u,a,R,S) scores across roles because score-level aggregation provides no mechanism to deduplicate permissions:

$$Risk ( u , a , r , S ) = {w}_{crit ( a )} logistic ( m , x 0 , g , {[ {( {\sum }_{r ∈ R} {\sum }_{p ∈ r} ( 1 + {w}_{n} ( a , p ) ) {1}_{s ( p ) ∈ S} {w}_{c ( v ( p ) )} {w}_{l ( p )} {\prod }_{j} ( 1 + {f}_{j} ( p ) {w}_{j} ) )}^{y} ]}^{1 / y} )$$

Normalizing Role Risk with the Logistic Function

The generalized logistic function is defined as follows:

$$l ( x ) = \frac{m}{1 + {e}^{- g ( x - x 0 )}} + y 0$$

To parameterize the logistic function so that the normalized score ranges from 0 to 100, the boundary conditions 1(0)=0 and 1(∞)=100 are applied. Solving for the parameter y₀ under these conditions ensures that the function passes through the origin and yields the following formulation:

$${y}_{0} = s / ( 1 + {e}^{{gs}_{0}} )$$

### Identity Risk

The BIRS values associated with policies assigned to an identity may be attributed to the identity for purposes of computing an identity-level risk score. Identity Risk (IR) may be represented as a numerical score that reflects the overall risk associated with an identity across all cloud service providers to which that identity has access. The IR score enables customers to identify identities that warrant review or corrective action. In some embodiments, the IR score may be derived from a plurality of contributing factors, including static attributes associated with the identity, behavior of the identity, and a provider level risk associated with the identity.

### Static Attributes

Static attributes characterize the authentication purpose and inherent security strength of an identity and may be obtained from an identity provider (e.g., Okta, Ping) or directly from a cloud provider when a native identity and access management service is used. For human identities, such static attributes may include the status and strength of multi-factor authentication (MFA), password strength, password rotation history, and the lifecycle state of the identity (e.g., enabled, deactivated, suspended, or stale). For service identities, static attributes may include whether console access is permitted, the lifecycle state of the identity, access key hygiene (including frequency of key rotation and unused or excessive key issuance), whether the service identity is shared across multiple applications, and the presence of a designated human owner responsible for the identity. In some embodiments, human ownership information for service identities may be maintained within a customer configuration management database (CMDB) or configured within a cloud management system. For external identities, static attributes may include identification of an internal human owner responsible for the external identity, classification of the third party associated with the identity, and when available, information stored within a customer CMDB regarding the external entity.

### Identity Behavior

Behavior may be treated as a dynamic attribute indicative of potential compromise of an identity and of the need for timely corrective action to mitigate further damage. In some embodiments, behavioral indicators may be derived from identity provider (IdP) event logs, cloud provider audit logs, and event logs generated by a cloud management or monitoring system. For human identities, behavioral indicators may include geo-location anomalies, such as “impossible travel” events in which an identity attempts access from two different countries within a short period of time, unusual travel patterns involving multiple, geographically distant locations in a short time interval, access attempts from locations not previously observed for that identity, or scenarios in which authentication occurs in one geographic region while the corresponding application activity occurs in another. Additional geo-based indicators may include access from locations inconsistent with the user's home location as recorded in human-resources systems. Device-based anomalies may include access from previously unseen devices as determined through device fingerprinting techniques. Temporal anomalies may include activity occurring during atypical hours for that identity or continuous activity for an extended period of time that would be abnormal for a human user. Failure-related anomalies may include elevated rates of authentication or authorization failures, including excessive multi-factor authentication challenges or failures. Usage-based anomalies may include behavioral patterns outside of a user's historical norms, performance of identity and access management operations that deviate from the identity's typical usage profile, significant deviations from peer-group behavior, bulk data export activity, or repeated operational failure (e.g., elevated HTTP 404 responses). Potential sabotage behavior, such as mass deletion, overwrite, or encryption of data, or deletion of infrastructure components, particularly where the identity is not the original creator, may also be considered behavioral indicators. Behavioral attributes may further include inactivity signals, such as lack of activity across systems that are ordinarily accessed contemporaneously during normal work periods.

For service identities, behavioral indicators may include anomalous IP address usage, such as access originating from both internal and external IP addresses when such behavior is unexpected, access from multiple external IP addresses, or access from newly observed external IP addresses. Usage-based anomalies for service accounts may include activity outside of the account's expected behavioral profile, excessive authorization failures, or repeated operational failures not directly related to authorization. Inactivity of a service identity may also be considered an indicator. For external identities, behavioral indicators may include access from multiple or newly observed external IP addresses, usage patterns that deviate from prior behavior, excessive authorization failures, or operational failures indicative of abnormal or suspicious behavior. Collectively, these dynamic behavioral attributes may be used, individually or in combination, to assess a behavioral-risk component associated with the identity.

### Provider Level Risk

Provider Level Risk for an identity represents the potential blast radius or extent of impact that could result in the identity were to be compromised, aggregated across all cloud service providers to which the identity has access. In some embodiments, the provider level risk may be determined as a function of the provider-scope blast impact risk calculated for that identity within each individual provider environment. Contributing factors may include the presence of risky or high-impact privileges assigned to the identity within accounts across the various providers. The IR score enables customers to identify high-risk identities and take appropriate corrective measures to reduce such risk. Risk reduction actions may include strengthening or remediating static configuration attributes associated with the identity and reducing excessive or unnecessary permissions granted across provider environments. Dynamic behaviors associated with authentication anomalies or anomalous activity within a provider environment generally cannot be proactivity remediated in advance, as they are based on time-varying behavioral analysis, however, such behaviors may be mitigated through appropriate and timely response actions once detected.

### Identity Risk Calculation

In some embodiments, the initial formulation for computing IR applies a normalized scale, such as 0-100, to a weighted combination of three components: (i) static configuration risk, (ii) behavioral risk, and (iii) provider level risk.

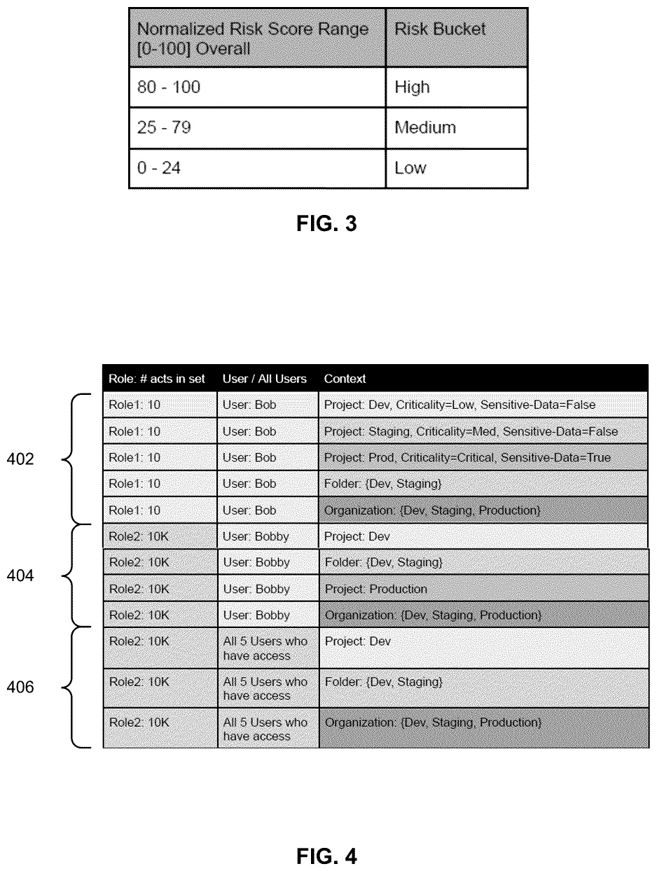

The system computes blast-risk scores to represent the potential impact an identity's granted roles may have within a given context. These scores may range from 0 to 100 (in other embodiments, different ranges are used) and are presented as whole numbers for usability. As seen in FIG. 3, blast-risk values are grouped into three qualitative levels: High, Medium, and Low.

Blast risk for a role binding, or set of bindings, is measured based on the scope over which the role is effective. A role is a collection of permissions assigned to a user or group, either directly or through policies. The scope may vary by provider; for example, in GCP, a role may apply at the resource level, project level, folder level, or organization level. Broader scope bindings inherently increase blast risk.

FIG. 4 is an example illustrating how risk bindings capture the varying levels of blast-impact risk associated with the same role when assigned under different contextual conditions. In the first set of rows 402, Role 1, which contains only 10 actions, is assigned to a single user (“Bob”) across progressively broader and more sensitive environments: from a low-criticality development project, to staging, to a production environment containing sensitive data, and finally at folder and organization scope. Although the role itself does not change, the risk increases significantly as the scope of impact and data sensitivity expand. The second set of rows 404 demonstrates the same concept with Role 2, a much more powerful role containing 10,000 actions. Here, the role is assigned to another user (“Bobby”) at project, folder, production, and organization scopes, showing dramatically higher blast-impact potential due to both the size of the role and the breadth of its scope. The final set of rows 406 further amplify the risk by assigning Role 2 to all five users with access, illustrating how risk compounds when high-impact permissions are distributed across multiple users.

In a first embodiment, an identity risk score (e.g., Risk 1.0) is determined by selecting the highest-risk role or permission binding associated with the identity. In this approach, the identity's risk corresponds to the maximum risk value among all of the identity's bindings within the applicable scope: risk(identity)=max(risk(identity,role,context)∈scope)). This approach requires minimal computation and is suitable for environments with limited processing constraints. A limitation of this approach is that a binding at a broad scope and a binding at a narrow scope may produce identical risk values, and multiple risky bindings do not increase the overall score beyond the highest individual binding.

In a second embodiment, an identity risk score (e.g., Risk 2.0) is determined by aggregating the risk scores of a plurality of bindings associated with the identity. Two aggregate risk notions are considered. One formulation is based on impact metrics and remains unbounded, while the other produces a bounded score, for example, in the range of [0-100].

The overall attack surface/impact of a set of roles or identities is computed using the impact-metric formulation, which evaluates raw risk values without logistic normalization. The impact score for a specific identity, scope context, and role is as follows:

$$Impact ( u , a , r , S ) = {w}_{crit ( u )} ( {[ {\sum }_{p ∈ r} ( 1 + {w}_{n} n ( a , p ) ) {1}_{s ( p ) ∈ S} {w}_{c ( v ( p ) )} {w}_{l ( p )} {\prod }_{j} {( 1 + {f}_{j} ( p ) {w}_{j} )}^{y} ]}^{1 / y} )$$

As an example, to compute the attack surface risk at a scope hierarchy level above the account level, or across all users in a scope, or across all roles accessible by the user, additional summations are added. For example, to compute impact across all users U, at scope=Whole-Organization O, and for all roles R bound to any identity anywhere in the organization, the following aggregation is used:

$${Impact ( U , Org , R , S ) = {{w}_{crit ( u )} ( [ {\sum }_{u ∈ U} {\sum }_{a ∈ O} {\sum }_{r ∈ R} {\sum }_{p ∈ r} ( 1 + {w}_{n} n ( a , p ) ) {1}_{s ( p ) ∈ s} {w}_{c ( v ( p ) ) ) {w}_{l ( p )}} {\prod }_{j} ( 1 + {f}_{j} ( p ) {w}_{j} ) )}^{y} ]}^{1 / y} )$$

Aggregation may also be performed across all users in a single account, which introduces only the summation over users in U, or to look at a single user's risk across all roles R accessible to the user in a single account, which would only add the summation over all roles in R. Crucially however, within a single scope, the permissions may be deduplicated to which a user has access, because the risk is the same if the user can access a permission via one role or via several. However, permissions available in different scopes are not deduplicated, since access to the same permission in multiple scopes contributes to additional attack surface.

The aggregation function may be an Lₚ-norm (e.g., an L₂ norm). The aggregated score may then be normalized, such as using a logistic or other mapping function, to produce a final identity risk score. This embodiment more accurately reflects cumulative access exposure across multiple bindings and/or binding scopes.

The risk-scoring model is intended to satisfy the following constraints: (a) a binding at a broader scope must result in a higher risk score than a binding at a more restricted scope; (b) risk levels are defined as High=[e.g., 80-100], Medium=[e.g., 25-80], and Low=[e.g., 0-25]; (c) a binding's risk should be High if one or more associated bindings are High; (d) a binding's risk should be Medium if one or more associated bindings are Medium and none are High; (e) a binding's risk should be Low if the highest associated binding is Low; and C(f) increasing the number of identities in an account must not decrease the account's risk score. For example, an account with one identity at risk 100 must be considered less risky than an account with thirty identities at risk 1 and one identity at risk 100.

For an individual user to reach a risk score of 100 under this model, the assigned roles must be highly risky, and the number of critical accounts to which that user has access must also be high.

For an account to be classified as highly risky, it must contain a large number of users who individually hold access to very high-risk roles within that account.

Threshold values may be adjusted based on the number of accounts configured within the tenant and the number of identities provisioned across those accounts.

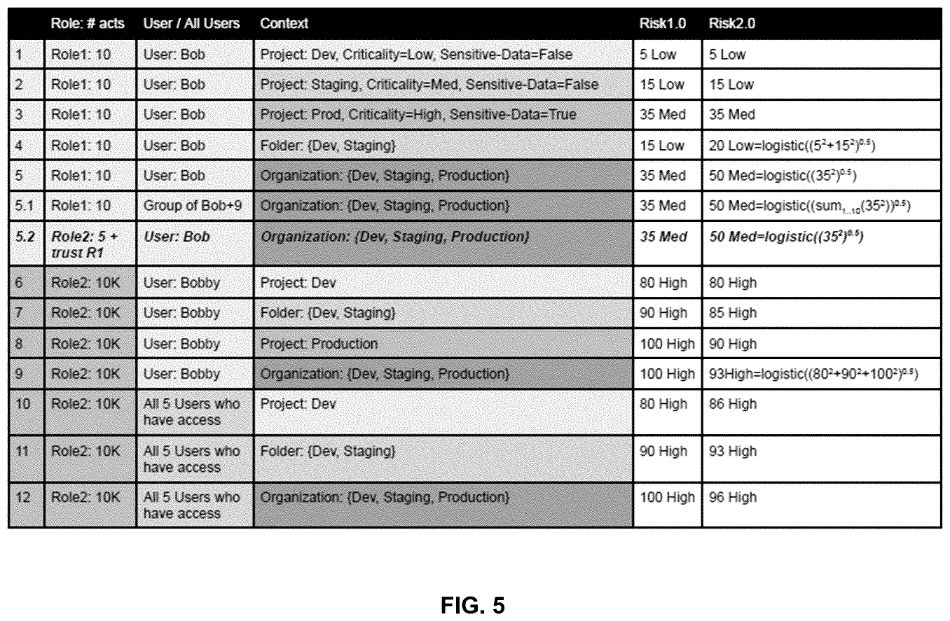

As seen in FIG. 5, the different identity-level risk calculation approaches produce different results when evaluating black-impact risk across various role bindings. The “Risk 1.0” analysis assigns the identity's risk based solely on the single highest-risk binding. In contrast, the “Risk 2.0” analysis introduces a logistic aggregation function, which increases the risk score when multiple medium-risk bindings accumulate or when risk compounds due to broader exposure.

### Account Risk

Account Risk (AR) represents the aggregate risk associated with all identities that have access to a given account. AR is derived from the BIR of each identity within the account using an account-level aggregation function. In some embodiments, the initial function to calculate AR is the maximum BIR among all the identities assigned to the account.

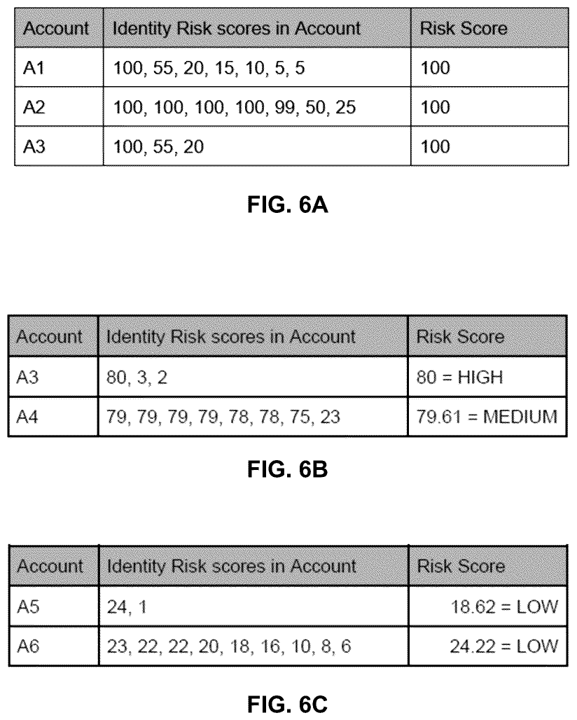

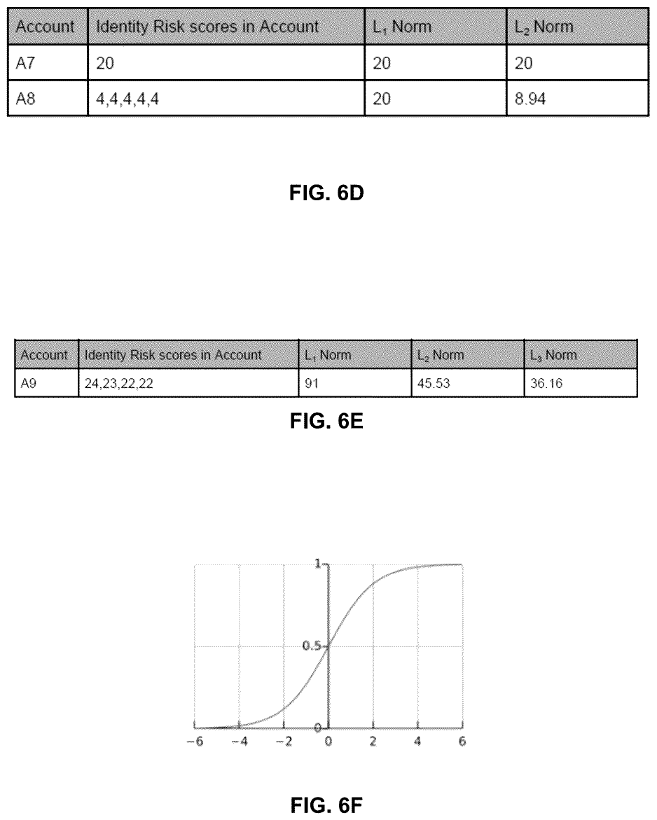

As in illustrated in FIG. 6A, in certain scenarios, account A2 may present a materially higher risk posture than account A1, however, under some conventional scoring approaches, even if account A2's constituent identity risk levels were reduced to resemble those of account A1, the resulting account-level risk score would remain unchanged. Such scoring outcome fails to adequately reflect meaningful improvements in the underlying identity risk distribution.

In some embodiments, the account-level risk scoring methodology is designed to satisfy several constraints. First, the number of high-risk identities associated with an account should influence the resulting account-level risk score, as a scoring function that relies solely on the maximum constituent identity score fails to capture this dimension. Risk levels may be categorized as HIGH (e.g., 80-100), MEDIUM (e.g., 25-80), and LOW (e.g., 0-25). Based on these thresholds, an account should be classified as HIGH risk if it contains one or more identities whose risk level is within the HIGH range, classified as MEDIUM risk if its highest-risk identity falls within the MEDIUM range, and classified as LOW risk if its highest-risk identity falls within the LOW range. Additionally, the point at which an account's score reaches its maximum value may depend on the total number of identities within the provider environment. For example, the scoring model may require that a defined percentage of identities (e.g., 10% or 20%) possess a risk score of 100 before the account's overall risk score reaches 100. Further, an increase in the number of identities associated with an account should not reduce the account-level risk score. As an illustrative example, an account with a single identity having a risk score of 100 should be treated as less risky than an account with thirty identities each having a risk score of 1 and one identity having a risk score of 100.

The application of the foregoing risk-level constraints may, in certain instances, produce edge cases that yield atypical scoring outcomes. However, such outcomes are acceptable because the scoring methodology assigns deliberate significance to the 25- and 80-point thresholds, such that identities with scores above 80 are treated as materially more critical than those with scores below that threshold. FIG. 6B illustrates an example of such an acceptable edge case.

A consequence of applying the above constraints is that regardless of how many identities within an account have risk scores just below the 80-point threshold, the account's overall risk will remain capped within the MEDIUM risk level; a similar effect applies with respect to the LOW risk level. As illustrated in FIG. 6C, it is therefore possible for account A6 to receive a higher numerical risk score than account A5, even where the highest individual identity risk score in A5 exceeds the highest individual identity risk score in A6.

The risk scores for accounts A1, A2, and A3 each include at least one identity classified as HIGH risk and therefore their account-level risk scores must fall within the [80-100] range. Account A4's highest-risk identity is within the MEDIUM range and accordingly its account-level risk score should fall within the [25-80] range. Accounts A5 and A6 each have a highest-risk identity within the LOW range and therefore their account-level scores should fall within the [0-25] range. Thus, a scoring function ƒ is sought that satisfies these constraints. For an account A, which may be represented as a set of identity-level risk scores, the function ƒ(A) should yield an account-level value that is not less than the minimum value in the set. By way of example, the desired function may yield the following results:

$$\begin{matrix}risk ( A 1 ) = f ( \{ 20 \} ) + 80 \\ risk ( A 2 ) = f ( \{ 20 , 20 , 20 , 20 , 19 \} ) + 80 \\ risk ( A 3 ) = f ( \{ 0 \} ) + 80 \\ risk ( A 4 ) = f ( \{ 54 , 54 , 54 , 54 , 53 , 53 , 50 \} ) + 25 \\ risk ( A 5 ) = f ( \{ 24 , 1 \} ) + 0 \\ risk ( A 6 ) = f ( \{ 23 , 22 , 22 , 20 , 18 , 16 , 10 , 8 , 6 \} ) + 0\end{matrix}$$

In some embodiments, if an account contains more than 100 identities, the number of identities used in the computation may be sampled or normalized to 100. This prevents exceptionally large accounts (e.g., with more than 1,000 users) from receiving disproportionately elevated risk scores solely due to their size. Thresholds may therefore be calibrated using a reference assumption of 100 identities. Accounts with fewer than 100 identities may consequently score as less risky than accounts with 100 or more identities, which may be desirable. The threshold of 100 identities may be adjusted in other embodiments.

The aggregation function may be configured to perform two primary operations. First, the function determines how to combine the identity-level risk scores within an account to produce a preliminary or “raw” account-level risk score. Second, the function normalizes the raw risk score to ensure that the resulting account-level score remains within the appropriate risk band for the account (e.g., [0-25], [25-80], [80-100]).

### Component 1: Combining Identity Risks to Obtain Raw Risk Scores

A naïve approach to computing a raw account-level risk score would be to sum the individual risk scores of each identity in the count, as illustrated in 6D. However, such a linear aggregation produces undesirable results.

Under a simple summation model, two accounts, such as A7 and A8 may receive identical raw risk scores despite having materially different risk postures. In practice, the blast impact of a breach is more closely aligned with the highest potential damage from the compromise of a single high-risk identity rather than the cumulative sum of several low-risk identities. Accordingly, account A7 should be treated as riskier than account A8, even where their summed identity-level scores are equal.

To better reflect this intuition, the Lₚ norm may be employed to combine identity-level risk scores. The Lₚ norm provides a parameterized aggregation mechanism that gradually shifts the weighting from average-based behavior (lower p values) toward maximum-dominated behavior (higher p values). For a set of identity-level risk scores, the Lₚ norm may be defined as follows for values of p≥0:

$$Risk ( a ) = {{\sum }^{i ∈ a}}_{i} {( {risk ( i )}^{p} )}^{{v}_{p}}$$

Different values of the parameter p in the Lₚ norm produce different aggregation behaviors and therefore yield different raw risk scores.

When p=1, the L₁ norm corresponds to the linear sum of individual identity risk scores for each identity/in the account, as shown in:

$$Risk ( a ) = {{\sum }^{i ∈ a}}_{i} ( risk ( i ) ) .$$

This is the formulation used in the earlier example comparing accounts A7 and A8.

When p=2, the L₂ norm corresponds to the square root of the sum of squared identity risk scores:

$$Risk ( a ) = {{\sum }^{i ∈ a}}_{i} {( {risk ( i )}^{2} )}^{{v}_{p}}$$

This approach increases the weight of higher individual risk scores relative to lower scores, thereby elevating the influence of high-risk identities.

As p approaches infinity, the Lₚ norm converges to the L_{∞} norm, which yields the maximum identity-level risk within the account. This is equivalent to a max-based aggregation function. However, a max-only approach is not desirable for the reasons previously described, including its failure to account for multiple high-risk identities or identity count-based risk density.

Selecting the L₂ norm may provide a balanced compromise between emphasizing high-risk identities and incorporating contributions from lower-risk identities. Applying the L₁ and L₂ norms to the identity-level risk distributions of accounts A7 and A8 yields the results shown in FIG. 6D. These results demonstrate that, while the L₁ norm assigns equal scores to A7 and A8, the L₂ norm appropriately assigns a higher score to A7, reflecting its greater exposure due to a single high-risk identity.

Component 2: Normalizing L₂ Raw Scores into Risk Level Ranges

Raw risk scores produced using the L₂ norm may exceed the intended bounds of the applicable risk level range, and the same may occur when applying other Lₚ norms. For example, consider account A9, which includes identity-level risk scores of 24, 23, 22, and 22. The L₁, L₂, and L₃ norm calculations for this account yield the results shown in FIG. 6E. Because raw norm-based scores can grow arbitrarily large as the number of identities increases, these values must be normalized to fit within the designated risk-level interval for the account. Accordingly, a normalization function is required that compresses raw values while asymptotically approaching the upper bound is the applicable range. In some embodiments, a shifted and scaled logistic function may be used to perform this normalization. By using the upper half of the logistic curve (shown in FIG. 6F) and applying appropriate transformations, the normalized score remains bounded within the target risk range while preserving relative distinctions between raw values.

In certain embodiments, a logistic function may be used to normalize raw risk scores into the appropriate risk-level range. Various functional forms may be used to achieve the desired asymptotic behavior, however, one suitable formulation is shown below, where a, b, and c are constants selected to align the curve with the target range:

$$Logistic ( x ) = \frac{Supremum}{1 + {e}^{- growth ( x - x 0 )}} + y 0$$

For the LOW risk range (e.g., 0-25), the logistic function may be parameterized such that Logistic(0)=0. In this case, the following parameters may be selected:

$$\begin{matrix}Supremum = 50 \\ y 0 = - 25\end{matrix}$$

x0=0 (chosen to utilize the upper half of the logistic curve, which provides the desired shape).

growth=0.08 (selected based on the values used in previous examples; alternative growth rates may be selected to adjust the slope of the curve)

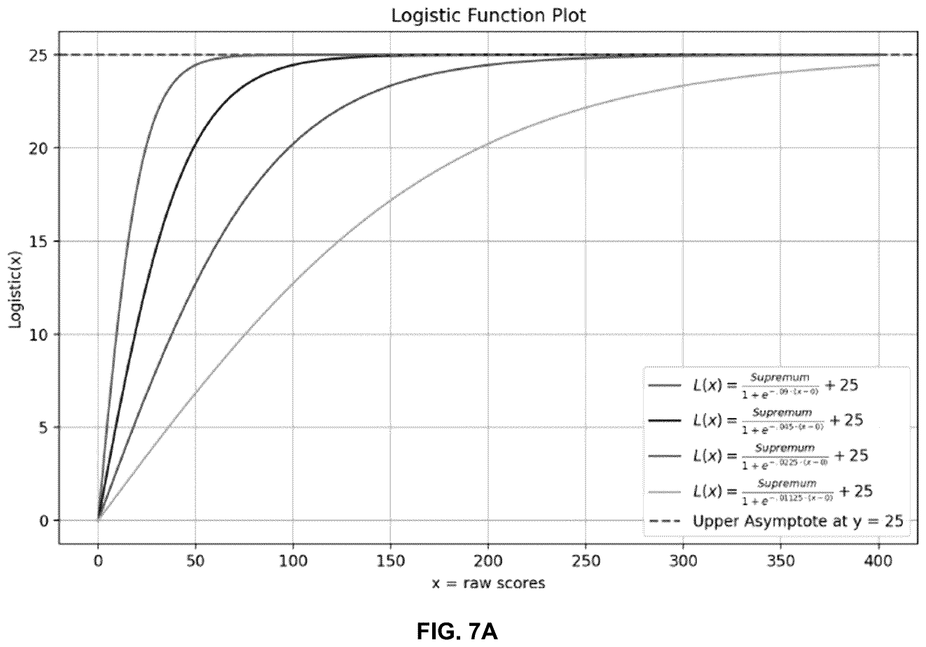

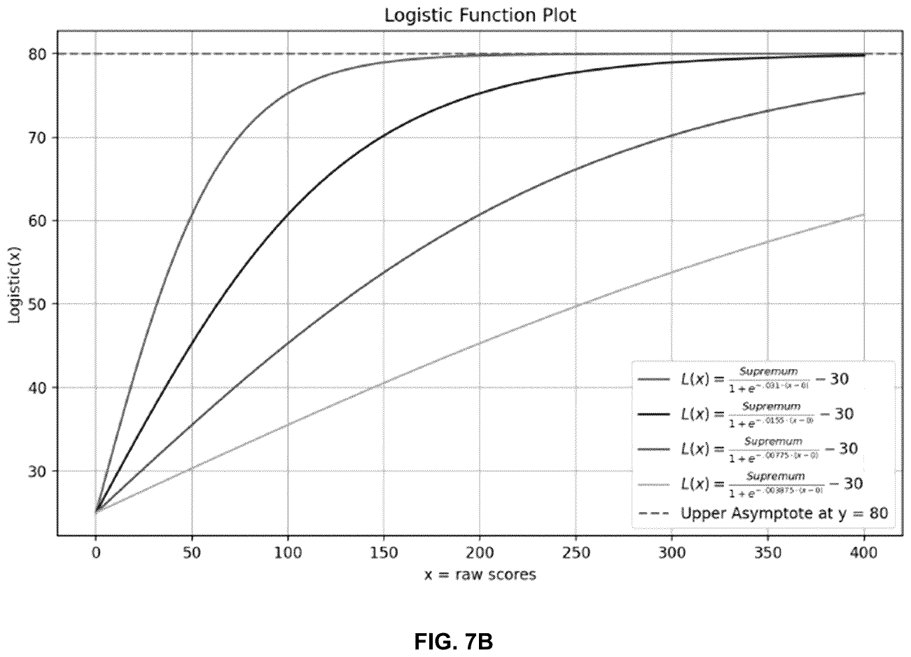

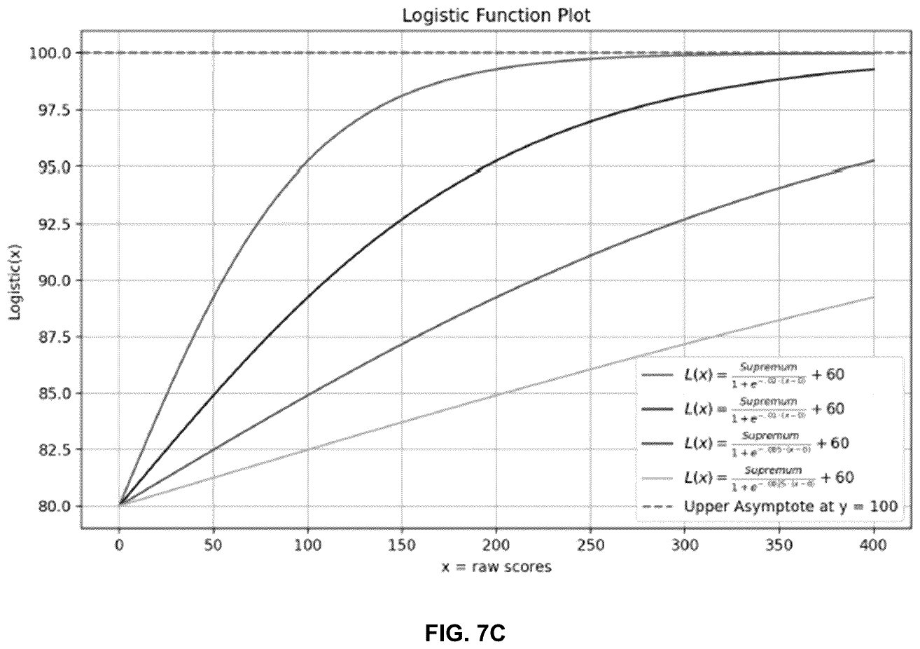

A sample plot of this function, shown in FIG. 7A, demonstrates that the curve approaches the upper bound of the designated interval asymptotically, ensuring that raw scores remain contained within the intended risk-level ceiling.

For the MEDIUM risk range (e.g., 25-80), the logistic function may be configured such that logistic (25)=25, reflecting the lowest possible score for an account that contains at least one identity with a MEDIUM-level risk score. To bound the range at 80, the maximum range width is 55 (80-25). Accordingly, the following parameters may be selected:

$$Supremum = 110$$

y0=−30 (to ensure that Logistic (25)=25; if y0 were set to 0, Logistic (0) would equal 55, i.e., half of the supremum)

growth=0.031 (selected to normalize larger values and ensure that the supremum is reached at approximately the same number of high-risk identities as in the LOW-range case)

In general, when x0=0 and the upper half of the logistic curve is used, the following relationships hold for refitting the curve between two bounds a and b:

$$\begin{matrix}Supremum = 2 ( b - a ) \\ y 0 = 2 a - b\end{matrix}$$

If x0 is non-zero, the function will not represent the upper half of the logistic curve and may not meet the desired normalization behavior.

A sample plot of this function, shown in FIG. 7B, demonstrates that the curve approaches the upper bound of the designated interval asymptotically, ensuring that raw scores remain contained within the intended risk-level ceiling.

For the HIGH risk range (e.g., 80-100), the logistic function may be configured such that the normalized score begins at 80 and asymptotically approaches 100. In this configuration, the following parameters may be selected:

$$\begin{matrix}Supremum = 40 \\ y 0 = 60 \\ x 0 = 0 \\ Growth = 0.02\end{matrix}$$

Because the width of this range (20 points) is smaller than the MEDIUM range and normalization must accommodate larger raw values, the growth parameter may be selected to be lower than the values used for the [0-25] and [25-80] ranges. This ensures that the curve reaches the upper bound of the range (i.e., 100) at approximately the same number of high-risk identities as in the LOW and MEDIUM ranges, while still compressing large raw Lₚ norm values into the appropriate interval.

The curve in FIG. 7C demonstrates that as raw risk scores increase, the normalized account-level score approaches 100 asymptotically while preserving differentiation among scores at lower portions of the range.

### Provider Risk

Provider Risk (PR) represents the aggregated risk associated with all accounts within a given cloud provider. PR is derived from AR values computed for each account belonging to the provider.

In some embodiments, PR may be determined by selecting the maximum AR value across all accounts associated with the provider.

In some embodiments, PR for a provider p is computed using a summation of account-level risks according to the following function:

$$Risk ( p ) = {{\sum }^{a ∈ p}}_{j} {{\sum }^{i ∈ a}}_{i} {( {risk ( i , j )}^{2} )}^{1 / 2}$$

where risk (i, j) represents the risk score for a resource i in account j.

The resulting PR value may be passed through a logistic normalization function to map the score to a bounded scale, such as a 0-100 scale. This approach treats the provider as a single aggregated account for the purposes of risk modeling. The logistic growth rate may be parameterized based on provider size or other relevant scaling factors.

### Least Standing Privilege

Least Standing Privilege (LSP) refers to the minimum set of standing permissions that an identity requires to perform its normal, recurring operations within a cloud provider environment. The term “least” may be defined in various ways depending on the organizational risk tolerance, configuration thresholds, and the criticality of the environment in which the permissions are exercised.

### LSP for Human Identities

For human identities, only permissions that are both (i) frequently used within an observation period and (ii) classified as low-risk are considered eligible to remain as standing permissions. All other permissions in a policy are treated as not required for standing access. The classification of a permission as low- or high-risk is based on a configured blast-impact threshold, which may vary depending on the criticality and sensitivity of the account in which the permission is granted. For example, a modification-type permission may be considered high-risk in a production account sensitive data, but low-risk in a development account without sensitive data.

Permissions within a policy may be categorized into four groups to determine whether they are included in LSP: (1) frequently used and low-risk permission, which are included in LSP; (2) high-risk permissions, which are excluded from LSP regardless of usage; (3) infrequently used permissions, which are excluded from LSP due to insufficient usage frequency distributed across the evaluation period; and (4) unused permissions, which are excluded from LSP if no usage is detected during the observation period.

### LSP for Service Identities

Service Identities (e.g., machine or system accounts) do not exhibit human-driven usage patterns and therefore LSP cannot be determined for such identities using the above criteria. Instead, the system identifies permissions that have not been used by the service identity during the observation period and designates them as excessive, enabling administrators to evaluate and remove unnecessary standing access for service identifiers.

For service identities, the determination of whether a permission is “used” is based solely on usage within the observation window. If a permission is used at least once during the period, it is considered used; otherwise, it is flagged as excessive. Account criticality or sensitivity is not considered for this determination. Notwithstanding, the system may still compute categorical breakdowns of permissions for service identities for reporting and analysis.

### Usage Frequency Determination

Usage frequency is determined based on a distribution of usage over time rather than total invocation count. For example, within a 30-day evaluation window, if a permission is used twice every two days, the usage count is 30 and the frequency distribution is 15. If a permission is used 30 times in a single day during the same period, the usage count remains 30, but the frequency distribution is 1. In this example, the former would be considered frequently used, whereas the latter would be considered infrequently used.

### Retention and Customization of LSP

Permissions that qualify for inclusion in LSP are retained for a defined retention period to avoid volatility in the LSP set. In some embodiments, a permission included in LSP is retained for a minimum of seven days (or other time frame) before re-evaluation. Additionally, a permission may not be added to LSP until sufficient usage is observed, such as a second use within a short time interval or consistent weekly usage during the evaluation period. If usage drops below the threshold over time, the permission may be removed from the LSP set.

Customer administrators may configure the usage frequency threshold used to evaluate eligibility for LSP. The system may compute LSP using both customer-defined and system-recommended thresholds for validation purposes. However, system-recommended criteria may be used for default or standardized calculations. A user interface may provide a visualization showing the permissions of a policy grouped into four categories: used low risk, high-risk, infrequent, and unused. The UI may further allow administrators to adjust blast-impact or frequency thresholds and view the resulting effect on risk scores.

### LSP Policy Rules

LSP policy rules define the criteria used to determine whether a permission is considered low-risk or high risk for purposes of inclusion in a LSP permission set. These rules may be configured as global defaults and may additionally be customized by individual tenants based on their security posture, operational requirements, or regulatory constraints. The thresholds set forth in this table determine the risk classification of a permission and therefore influence whether the permission may remain as standing access.

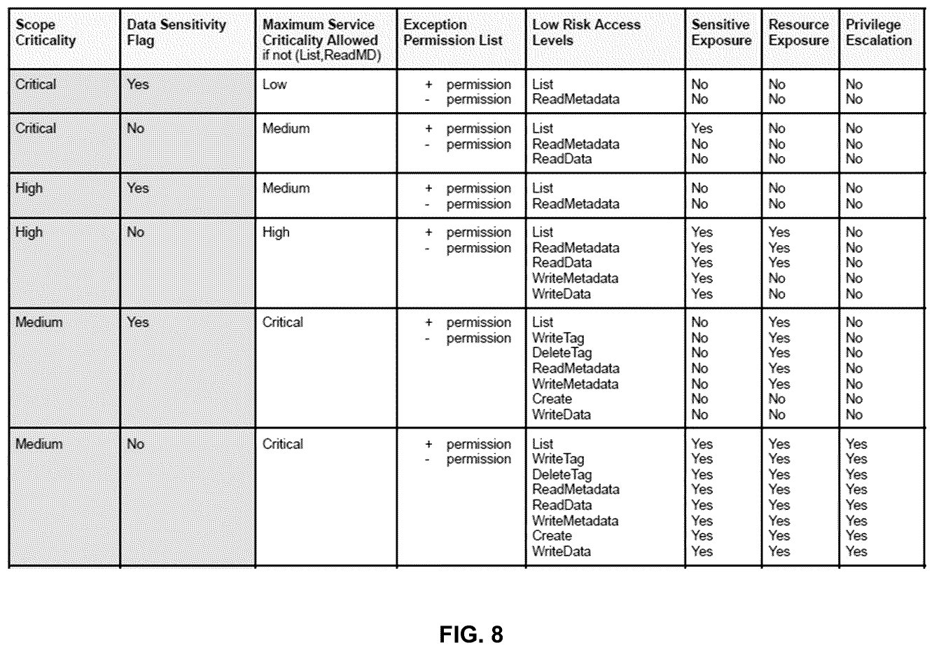

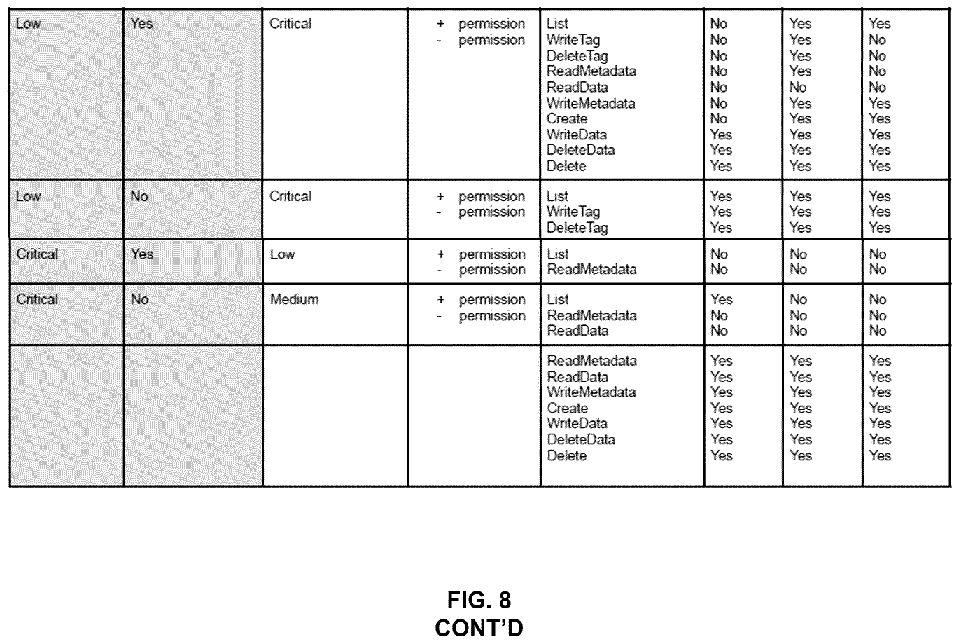

The LSP policy rules incorporate both the criticality of the scope in which the permission is granted and whether the scope contains sensitive data. These contextual attributes significantly affect the risk associated with a permission and consequently impact its eligibility for LSP. As shown in FIG. 8, the global default configuration specifies, for each combination of scope criticality and data sensitivity, the maximum criticality level permitted for a permission to remain in LSP, any exception lists that may apply, the access levels considered to be low-risk in that context, and whether the permission entails sensitive data exposure, resource exposure, or privilege escalation risk.

In some embodiments, for a permission to be classified as low-risk within the context of its associated scope, the permission must satisfy all of the risk-screening criteria defined for that scope in the LSP policy table. These criteria may include one or more of the following dimensions: service criticality, exception designation, access level, sensitive data exposure, resource exposure, and privilege escalation potential. A permission that fails to satisfy any of the applicable criteria for the scope in which it is granted is deemed high-risk for that scope and therefore excluded from the LSP permission set.

### Excessive Privilege Score

Excessive Privilege Score (EPS) is a metric that quantifies the extent of excessive standing privileges assigned to an identity. EPS is expressed as a percentage and reflects the proportion of permissions within a policy that exceed the identity's LSP requirements. The factors used to determine excessive privilege differ for human identities and service identities, as described in the LSP criteria section above. EPS serves as an indicator to the tenant of the degree to which an identity has more standing access than required, and therefore highlights the opportunity to transition those permissions to JIT access. Reducing EPS toward zero indicates convergence toward a LSP state.

Once the LSP set has been determined for a policy assigned to an identity, the EPS for that identity with respect to that policy is calculated as follows:

$$EPS = 100 x \frac{( Total Permissions in the Policy - Permissions in LSP for the Identity )}{Total Permissions in the Policy}$$

An EPS of 0% indicates that all permissions assigned to the identity for that policy are required for standing use, whereas an EPS approaching 100% indicates that most of the permissions assigned to the identity exceed its LSP and may be candidates for removal or conversion to JIT access.

### Identity's EPS for a Policy

EPS is calculated at the identity level, as it depends on which permissions assigned to that identity are utilized versus unused. The identity EPS of a policy is determined as:

$$Identity EPS Score of a Policy = \frac{{\sum }_{p ∈ Non - LSP Permissions} ( EBI ( p ) \times Account Criticality / Sensitivity Index )}{EBI of the policy in that Account}$$

### Identity's EPS for an Account

The EPS score for an identity in an account may be calculated by aggregating the EPS numerators and denominators across all policies assigned to that identity within the account.

### Identity's EPS for a Provider

The same approach applies to computing the EPS of an identity at the provider level, whereby the EPS numerator and denominator are aggregated across all policies assigned to the identity in all accounts within that provider

Identity's EPS for a Tenant

The same calculation applies at the tenant level, where the EPS numerator and denominator are aggregated across all policies assigned to the identity in all providers within the tenant.

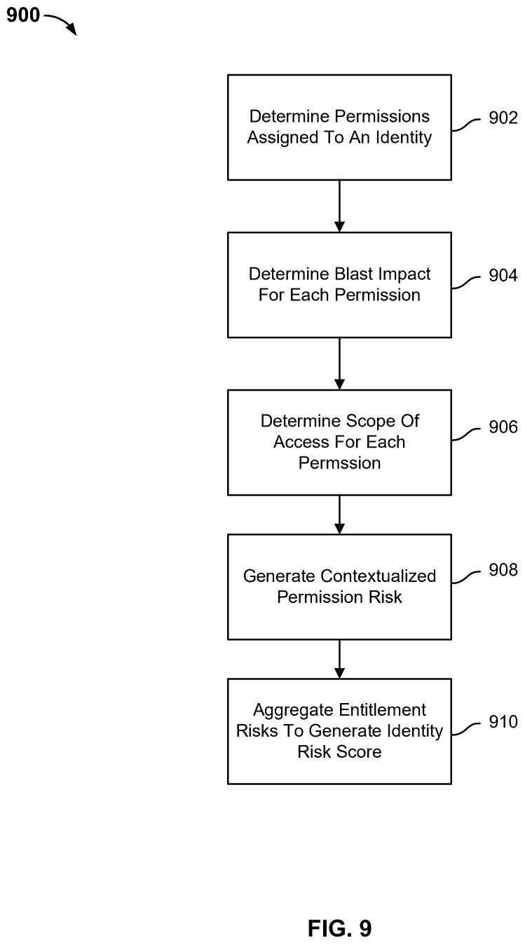

FIG. 9 is a flow diagram illustrating a process to determine a risk associated with an identity in accordance with some embodiments. Process 900 may be implemented by a permissions manager, such as permissions manager 212.

At 902, permissions assigned to an identity are determined. Permissions are not granted directly, but rather indirectly through roles (also referred to as policies or permission sets). To determine the permissions assigned to the identity, the permissions manager first identifies the one or more roles associated with the identity. A role is a collection of permissions that is assigned to a user or group within the context of a particular scope. The scope defines the set of resources to which the role applies. For example, in AWS, the scope of a role assignment is typically an account. In Azure, the scope of a role assignment may be a resource, a resource group, a subscription, or a management group. In GCP, the scope of a role assignment may be a project, a folder, or an organization.

At 904, a blast impact is determined for each permission assigned to the identity. The blast impact of a permission represents the potential impact or damage that could result if the permission were misused or if the identity were compromised. To determine the blast impact for a permission, the permissions manager evaluates a set of risk attributes associated with the permission, including the type of access granted by the permission (e.g., read, write, create, delete, or permissions management), the sensitivity of the data or resources accessible through the permission, the potential for privilege escalation, and the breadth of resource exposure associated with the permission. The blast impact of a permission is further influenced by the criticality level of the scope in which the permission applies, as well as whether the scope contains sensitive data. For example, a permission that allows modification of data in a production account containing sensitive data will have a higher blast impact than the same permission applied in a non-production account without sensitive data.

At 906, a scope of access is determined for each permission assigned to the identity. The scope of access identifies the set of resources to which the permission applies and defines the breadth of impact that the permission may have if misused. In cloud environments, the scope at which a permission is granted can vary by provider and may include fine-grained or broad administrative boundaries. For example, the scope of access for a permission in AWS is typically tied to an account, whereas in Azure, the scope may be a resource, a resource group, a subscription, or a management group, and in GCP, the scope may be a resource, a project, a folder, or an organization. The permissions manager determines the applicable scope for each permission by identifying the role assignment through which the permission was granted and extracting the scope associated with the role assignment. Permissions assigned at broader scopes provide access to a larger set of resources and therefore represent a greater blast radius and higher potential impact relative to permissions granted at narrower scopes. The determined scope of access for each permission is sued by the system to assess the breadth of exposure and to influence subsequent risk scoring for the identity.

At 908, a contextualized permission risk is generated. The contextualized permission risk represents a risk value for a permission after accounting for the context in which the permission is granted and exercised. Context includes factors, such as the criticality of the scope in which the permission applies, whether the scope contains sensitive data, and any characteristics of the permission that increase its potential for misuse, such as privilege escalation capability, resource exposure, or access to sensitive data. For example, a permission that enables modifications or deletion of resources within a production environment that stores sensitive data is assigned a higher contextualized risk than the same permission applied within a non-production environment without sensitive data.

To generate the contextualized permission risk, the system evaluates the blast impact of the permission together with the scope of access and applies one or more weighting adjustment factors associated with the context. The output of this step is a normalized risk score for the permission, such as a score on a 0-100 scale, that reflects how dangerous the permission is when considered within its actual deployment environment.

At 910, entitlement risks are aggregated to generate an identity risk score. The identity risk score represents an overall measure of the risk posed by the identity based on the set of permissions, roles, and scopes to which the identity has access. To generate this score, the system aggregates the contextualized permission risks associated with the identity across the roles and scopes in which the permissions are granted. The aggregation accounts for both the severity of individual high-risk entitlements as well as the cumulative effect of multiple medium-or low-risk entitlements that, when combined, increase the potential impact if the identity were to be compromised.

In some embodiments, the aggregation process includes applying a non-linear mathematical function that weights higher-risk entitlements more heavily than lower-risk entitlements to reflect that a single highly dangerous permission can significantly elevate the identity's overall risk. For example, the system may use a norm-based aggregation function to combine the individual entitlement risk values, such that the resulting identity risk scores increases as either (i) the risk of any single entitlement increases, or (ii) the number of risky entitlements assigned to the identity increases. The aggregated value may then by normalized into a bounded scale (e.g., 0-100) to generate the identity risk score.

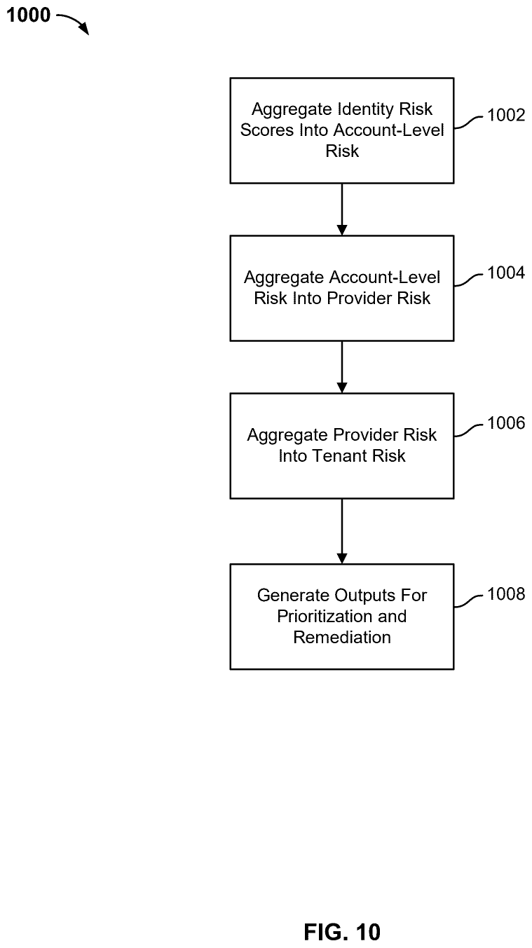

FIG. 10 is a flow diagram illustrating a process to determine a risk associated with a tenant in accordance with some embodiments. Process 1000 may be implemented by a permissions manager, such as permissions manager 212.

At 1002, identity risk scores are aggregated into account-level risk. The account-level risk represents the overall risk associated with an account based on the identities that have access to the account and the level of risk each identity poses. To generate the account-level risk, the permissions manager combines the identity risk scores of all identities with entitlements in the account. This aggregation captures both the presence of highly risky identities as well as the cumulative effect of multiple identities that may each have moderate or low individual risk but collectively increase the likelihood and potential impact of a security incident within the account.

In some embodiments, the aggregation applies a non-linear combination function that weights higher identity risk more heavily than lower ones so that a single highly risky identity elevates account risk significantly, while still allowing the account risk to increase as the number of risky identities grows. This avoids the shortcomings of using only the maximum identity risk, which fails to reflect improvements when one of several high-risk identities is remediated, and instead produces a more accurate representation of the account's overall exposure. The aggregated value may then be normalized into a bounded range (e.g., 0-100) to produce the account-level risk score. The account-level risk score may further be mapped into qualitative tiers, such as low, medium, or high based on predefined or configurable thresholds.

At 1004, each account-level risk is aggregated to into a provider risk. The provider risk represents an overall measure of risk for a cloud provider environment based on the combined risks of all accounts associated with that provider. To generate the provider risk, the permissions manager aggregates the account-level risk scores for all accounts within the provider. This aggregation captures both the presence of one or more highly risky accounts as well as the cumulative impact of multiple accounts that individually may have moderate or low risk, but collectively increase the overall exposure of the provider.

At 1006, each provider risk is aggregated into a tenant risk. The tenant risk represents an overall measure of risk for the entire tenant environment based on the combined risks of all cloud providers associated with the tenant. To generate the tenant risk, the system aggregates the provider-level scores for each provider linked to the tenant. This enables the system to produce a holistic view of the tenant's overall exposure, even when the tenant operations across multiple cloud platforms, accounts, and environments.

At 1008, outputs for prioritization and remediation are generated. Based on the computed risk scores, the permissions manager produces outputs that assist in determining which identities, accounts, providers, or permissions require remediation and in what order of urgency.

These outputs may include ranked risk lists, recommended entitlement removals or privileged reductions, proposed least-privilege policy configurations, and automated or semi-automated remediation actions, such as the removal of unused or high-risk entitlements or the conversion of standing privileges to just-in-time access.

In some embodiments, the permissions manager further identifies specific blast-radius drivers, unused permissions that contribute to excessive privilege, and contextual risk factors (e.g., sensitive-data access or privilege escalation vectors) to guide corrective actions. Remediation recommendations may be dynamically tailored based on tenant-define policies, compliance requirements, or operational constraints, and may include simulation or “what-if” impact analysis to preview the effect of proposed changes on user functionality and overall risk posture.

Outputs may be delivered through interactive dashboards, alerts, notifications, API integrations, or workflow orchestration systems to support timely and effective remediation. In some embodiments, remediation instructions may be exported to external identity-governance systems, ticketing platforms, or cloud-native controls, or executed directly by the permissions manager in accordance with configured authorization policies to ensure least-privilege access is enforced continuously at scale across the tenant environment.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
determining a plurality of permissions associated with a user;
determining a corresponding risk associated with each of the plurality of permissions;
determining an aggregate risk associated with the plurality of permissions associated with the user as a whole to generate an identity risk based on the determined corresponding risk associated with each of the plurality of permissions;
determining which of the plurality of permissions are used by the user; and
configuring one or more roles for the user based on the determined aggregate risk and the determined use.

2. The method of claim 1, wherein determining the plurality of permissions associated with user includes identifying the one or more roles associated with user.

3. The method of claim 1, wherein determining the corresponding risk associated with each of the plurality of permissions includes determining a corresponding blast impact.

4. The method of claim 3, wherein determining the corresponding blast impact includes evaluating a set of attributes associated with a permission of the plurality of permissions.

5. The method of claim 4, wherein the set of attributes includes a type of access granted by the permission, a sensitive of the data or resources accessible through the permission, a potential for privilege escalation, and/or a breadth of resource exposure associated with the permission.

6. The method of claim 1, wherein determining a corresponding risk associated with each of the plurality of permissions includes determining a corresponding scope of access for each of the plurality of permissions.

7. The method of claim 6, wherein the determined corresponding risk associated with each of the plurality of permissions is a contextualized permission risk.

8. The method of claim 7, wherein the contextualized permission risk is a value that is normalized with respect to a scale.

9. The method of claim 1, wherein configuring the one or more roles for the user includes applying a least standing privilege.

10. The method of claim 9, wherein configuring the one or more roles for the user includes configuring at least one permission associated with the one or more roles for just-in-time access.

11. The method of claim 1, further comprising aggregating corresponding identity risk scores associated with a plurality of users into an account-level risk.

12. The method of claim 11, further comprising, for a plurality of accounts, aggregating corresponding account-level risk into a provider risk.

13. The method of claim 12, further comprising, for a plurality of providers, aggregating corresponding provider risk into a tenant risk.

14. The method of claim 13, further comprising generating outputs for prioritization and remediation based on one or more of the identity risk, the account-level risk, the provider risk, and/or the tenant risk.

15. The method of claim 1, wherein determining the aggregate risk associated with the plurality of permissions includes:
deduplicating permission that are accessible to the user through multiple roles within a same scope such that a duplicate permission does not increase the aggregate risk; and
treating permissions available across different scopes as separate contributions to the aggregate risk.

16. A system, comprising:
a processor configured to:
determine a plurality of permissions associated with a user;
determine a corresponding risk associated with each of the plurality of permissions;
determine an aggregate risk associated with the plurality of permissions associated with the user as a whole to generate an identity risk based on the determined corresponding risk associated with each of the plurality of permissions;
determine which of the plurality of permissions are used by the user; and
configure one or more roles for the user based on the determined aggregate risk and the determined use; and
a memory coupled to the processor and configured to provide the processor with instructions.

17. The system of claim 16, wherein to determine the plurality of permissions associated with user, the processor is further configured to identify the one or more roles associated with user.

18. The system of claim 16, wherein to determine the corresponding risk associated with each of the plurality of permissions, the processor is further configured to determine a corresponding blast impact.

19. The system of claim 18, wherein to determine the corresponding blast impact, the processor is further configured to evaluate a set of attributes associated with a permission of the plurality of permissions.

20. A computer program product embodied in a non-transitory computer readable medium and comprising computer instructions for:
determining a plurality of permissions associated with a user;
determining a corresponding risk associated with each of the plurality of permissions;
determining an aggregate risk associated with the plurality of permissions associated with the user as a whole to generate an identity risk based on the determined corresponding risk associated with each of the plurality of permissions;
determining which of the plurality of permissions are used by the user; and
configuring one or more roles for the user based on the determined aggregate risk and the determined use.
